(19) United States
(12) Patent Application Publication
(10) Pub. No.: US 2009/0162509 A1
(43) Pub. Date: Jun. 25, 2009

(54) Sterilised Nutritional Beverage

(76) Inventor: Hermanus Theodorus K.M. Banken, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/084,932

(22) PCT Filed: Oct. 25, 2006
(86) PCT No.: PCT/EP2006/010321

§ 371 Date: May 13, 2008

(30) Foreign Application Priority Data
Nov. 14, 2005 (EP) 05077588.1
Nov. 14, 2005 (EP) 05077589.9
Mar. 1, 2006 (EP) 06075464.5

(51) Int. Cl. A23L 3/16

(52) U.S. Cl. 426/521

(57) ABSTRACT

One aspect of the invention relates to a sterilised nutritional beverage containing: 0.5-8 wt. % protein; 1-6 wt. % fat; 3-2 0 wt. % carbohydrates; up to 5 wt. % of optional other nutritional components; and 70-85 wt. % water; wherein the carbohydrates comprise, calculated on total weight of the beverage: 0.2-2.0% native starch; 2-10% saccharides, selected from the group consisting of monosaccharides, disaccharides, trisaccharides and combinations thereof. The present beverage can be stored under tropical conditions for several weeks without showing signs of destabilisation. Another aspect of the invention relates to a method of preparing a sterilised beverage as defined above.

### TECHNICAL FIELD OF THE INVENTION

The present invention relates to a sterilised nutritional beverage containing protein, fat, carbohydrates and water. The present beverage can be stored under tropical conditions for several weeks without showing signs of destabilisation. In particular, the nutritional beverage of the present invention exhibits exceptional stability against oil separation, flocculation and creaming. Furthermore, the present beverage can be prepared relatively easily using ultra high temperature (UHT) sterilisation conditions.

### BACKGROUND OF THE INVENTION

Sterilised nutritional beverages containing protein, fat and carbohydrates are known in the art. During processing, transportation and storage, destabilisation of the dispersed oil phase of these beverage can give rise to serious product quality problems. These stabilisation problems are particularly associated with flocculation, creaming and coalescence of the dispersed oil droplets. These dynamic phenomena can affect the appearance and sensory characteristics of the beverages.

U.S. Pat. No. 6,475,539 describes a shelf stable liquid enteral formula having a pH of from about 3.0-4.6 comprising:

a) from about 45-95% by weight water;
(b) from about 1.0-15% by weight of caseinate
(c) from 0.5-3.3% by weight of high methoxy pectin;
(d) from about 1-30% by weight of a carbohydrate;
(e) from about 0.5-10% by weight of an edible oil;
(f) sufficient quantities of protein, carbohydrate, and edible oil to serve as a sole source of nutrition, in a volume ranging from 1000-2000 ml,
(g) at least 100% of the adult RDI for vitamins and minerals, in a volume ranging from 1000-2000 ml, and;
(h) and said enteral formula has a shelf life of at least one year. The carbohydrate is preferably selected from the group consisting of dextrose, lactose, fructose, sucrose, maltose, corn starch, hydrolysed corn starch, maltodextrin, glucose polymers, corn syrup solids, oligosaccharides, high saccharides, high fructose corn syrup, and fructooligosaccharides. It is observed in the US patent that one aspect of the invention described therein relates to process of manufacture which produces a beverage with excellent physical stability even after retort sterilisation, aseptic packaging and hot-fill processes.

US 2005/0214432 describes a process for the preparation of a stable ungelatinised starch-containing oil-in-water emulsion in the absence of an added emulsifier and without forming a roux, which comprises subjecting a mixture of ungelatinised flour and/or starch, an oil and an aqueous liquid to high shear carried out at a temperature of less than 50° C. The emulsions described in the US application contain 1-15 wt. % flour and/or starch, 1-15 wt. % oil and 70-95 wt. % water. In a preferred embodiment, the emulsions contain 2-70 wt. % of a milk product. It is observed in the US application that a variety of flours and/or starches can be used, but that native flours and/or starches are preferred.

Thermodynamically speaking, oil-in-water emulsions are metastable systems which means that they are prepared using excess energy (mechanical in most cases). After a period of time which depends strongly on the preparation method and the product composition, the emulsion eventually phase separates in two phases. The phase separation involves coalescence of the oil droplets which grow as a function of time. This is an irreversible process.

Besides coalescence, oil-in-water emulsions often exhibit other types of destabilisation, notably flocculation and creaming. Flocculation, like coalescence, is a mechanism that involves the coming together of oil droplets. However, in case of flocculation no coalescence is observed, i.e. the oil droplets form aggregates that separate from the bulk. Creaming occurs in oil-in-water emulsions because the density of the oil droplets is lower than that of the continuous aqueous phase into which they have been dispersed. Due to this density difference, there is driving force that gradually moves the oil droplets to the top surface of the product.

As will be clear from the above, it is impossible to completely prevent the occurrence of coalescence, flocculation and creaming in oil-in-water emulsions such as the present nutritional beverage. However, by reducing the rate at which these phenomena occur, sufficient product stability can be achieved to ensure that product quality will remain acceptable throughout the product's shelf-life.

The speed at which coalescence, flocculation and creaming occur in oil-in-water emulsions increases rapidly with temperature increase. Another factor that accelerates these destabilisation phenomena are high solute concentrations in the aqueous phase. Nutritional beverages typically comprise aqueous phases with high solute concentrations due to the presence of substantial levels of proteins and carbohydrates.

Thus, it is a major challenge to provide nutritional beverages in the form of oil-in-water emulsions that can be stored for several weeks under tropical conditions without developing serious stability defects. In order to provide a nutritional beverage that can be stored for several weeks under tropical conditions, before being consumed, it must be ensured that no microbial spoilage occurs during this period. Effectively, this means that the product must be sterilised and packaged under aseptic conditions. Since sterilisation conditions favour coalescence of oil droplets, the product needs to be formulated in such a way that coalescence of oil droplets is not only prevented during storage and handling under tropical conditions, but also during sterilisation.

### SUMMARY OF THE INVENTION

The present inventors have realised this objective by developing a carefully balanced formulation that can be used to produce a sterilised nutritional beverage of exceptional storage stability. More particularly, the inventors have provided a sterilised nutritional beverage containing:
0.5-8 wt. % protein;
1-6 wt. % fat;
3-20 wt. % carbohydrates;
up to 5 wt. % of optional other nutritional components; and
70-85 wt. % water;
wherein the carbohydrates comprise, calculated on total weight of the beverage:
   0.2-2.0% native starch; and
   2-10%, preferably 3-10% saccharides, selected from the group consisting of monosaccharides, disaccharides, trisaccharides and combinations thereof.

Although the inventors do not wish to be bound by theory, it is believed that the combination of protein and native starch fulfils a critical role in stabilising the present nutritional product. It was surprisingly found by the present inventors that native starch can advantageously be employed to stabilise the present nutritional beverage. It is common practice to employ special modified starches in sterilised beverages. These modified starches, such as hydroxy-propylated starches can withstand very high temperatures, shear forces and extremes of pH. These modified starches have demonstrated their performance in UHT processed dairy foods, where, during processing, the starches resist gelatinization to give a low viscosity to assist flow through the plant. Not only have the inventors unexpected found that native starch can be used to stabilise the present sterilised nutritional beverage, but as a matter of fact, comparative studies showed that native starch actually outperformed modified starches that have been designed for use in UHT-sterilised products.

The present invention also provides a method of preparing such a sterilised nutritional beverage, said method comprising:
combining the protein, fat, carbohydrates, optional other nutritional components and water in a pre-emulsion;
homogenising the pre-emulsion; and
sterilising the homogenised pre-emulsion by heating it to a temperature of more than 130° C. for 2-30 seconds.

### DETAILED DESCRIPTION OF THE INVENTION

Accordingly, one aspect of the invention relates to a sterilised nutritional beverage containing:
0.5-8 wt. % protein;
1-6 wt. % fat;
3-20 wt. % carbohydrates;

up to 5 wt. % of optional other nutritional components; and
70-85 wt. % water;
wherein the carbohydrates comprise, calculated on total weight of the beverage:
0.2-2.0% native starch; and
3-10% saccharides, selected from the group consisting of monosaccharides, disaccharides, trisaccharides and combinations thereof.

The term “native starch” as used herein refers to a starch that has been isolated from a natural plant source and that has not been modified, e.g. by esterification or hydrolysis. Thus, the term “native starch” does not encompass maltodextrins. According to a particularly preferred embodiment the beverage contains at least 0.5 wt. % of native starch. In another preferred embodiment, the concentration of native starch does not exceed 1.5% by weight of the beverage. As mentioned herein before, the exceptional stability of the present beverage is believed to be associated with the combined use of protein and native starch in the indicated concentrations. Particularly good results have been obtained if the protein employed is dairy protein. Examples of suitable sources of dairy protein include milk, whey, skim milk, cheese, curd, casein, caseinate. Preferably, the present composition contains a source of dairy protein selected from the group consisting of milk, whey, skim milk, casein, caseinate and combinations thereof. These materials may be incorporated in the present beverage in dehydrated or liquid form, preferably in dehydrated, e.g. powder form. The protein content of the present beverage preferably is at least 1 wt. %, more preferably at least 2 wt. %, most preferably at least 3 wt. %.

According to a particularly preferred embodiment of the invention the nutritional beverage comprises 0.1-2 wt. % caseinate, e.g. sodium caseinate. The incorporation of caseinate in the indicated amounts was found to effectively stabilise the beverage against coalescence during sterilisation and storage.

The carbohydrate material contained in the present beverage includes native starch and saccharides. The saccharides are preferably selected from the group consisting of monosaccharides, disaccharides and combinations thereof.

The present beverage may suitably contain maltodextrin, e.g. in an amount of 3-10% by weight of the beverage. Particularly suitable maltodextrins have a DE in the range of 2 to 20. Preferably, the maltodextrin employed in the present beverage has a DE in the range of 10 to 20.

As explained herein before, the incorporation of high levels of carbohydrates favours physical destabilisation of the nutritional beverage. Nonetheless, it was found that stable beverages can be prepared in accordance with the present invention even if these beverages contain at least 6 wt. % or even at least 9 wt. % of carbohydrates.

The native starch applied in the present nutritional beverage may be obtained from various plant sources known in the art, such as potato, tapioca and maize. Preferably, the native starch is a native maize starch. Most preferably, the native starch is a native waxy maize starch.

The stability of the present beverage is advantageously further enhanced by the incorporation of 0.05-0.5 wt. % of monoglycerides, diglycerides or a combination thereof. Another ingredient that is advantageously incorporated in the nutritional beverage to prevent coalescence is the polysaccharide carrageenan. Preferably, carrageenan is incorporated in a concentration of 0.005-0.2 wt. %. Carrageenan is a complex carbohydrate extracted from red seaweed and provides stability in the present nutritional beverage through interaction with the protein, causing the formation of very weak thixotropic gels at low concentrations.

The nutritional beverage of the present invention is a pourable product. Typically, the present beverage has a viscosity (at 20° C.) in the range of 5-200 mPa·s at 10 s⁻¹. More preferably, the present beverage has a viscosity in the range of 10-100 mPa·s at 10 s⁻¹, most preferably of 10-50 mPa·s, meaning that the product is a thin liquid that can easily be swallowed. The viscosity of the present beverage is suitably determined by means of a Rheometer® AR1000, using a shear rate sweep from 0.01 to 250 s⁻¹ (in 510 s.) and a cone plate measuring system with a cone angle 2:0:38 (deg:min:sec), a cone diameter of 40 mm and a truncation of 54 microns.

The nutritional beverage of the present invention advantageously contains one or more minerals, especially transition metals such as iron and zinc. These metals are suitably incorporated in the beverage in the form of water soluble salts. Typically, the beverage contains at least 10 ppm of iron and/or zinc cations. Preferably, the beverage contains at least 10 ppm iron cations, more preferably at least 20 ppm iron cations. The content of iron cations usually does not exceed 200 ppm, preferably it does not exceed 100 ppm.

Other nutritional components, besides minerals, that may advantageously be incorporated in the present beverage include vitamins, sterols, flavonoids, carotenoids etc.

The fat contained in the present beverage preferably is a liquid non-hydrogenated oil containing at least 60% unsaturated fatty acid residues by weight of the total amount of fatty acid residues contained in said oil. Examples of suitable liquid oils include vegetable oils (sunflower oil, soybean oil, safflower oil etc.) and fish oils.

As explained herein before, the present beverage is an oil-in-water emulsion. The fat is preferably present in said beverage with a as dispersed droplets with an average diameter D_{3,2} of 0.1-3 μm, preferably of 0.3-2 μm. The average diameter D_{3,2} (i.e. the surface weighted average diameter) can suitably be determined by means of laser diffraction, using a Helos™ laser diffraction sensor (ex Sympatec GmbH) in combination with a 632.8 nm laser. Measurements are conducted at 20° C. using a QUIXEL™ wet dispenser ex Sympatec GmbH (at an optical concentration between 10 and 20%).

Typically, the excellent storage stability of the present beverage is evidenced by an increase of the average diameter D_{3,2} of less than 50% when the beverage is stored at 40° C. for one month. Under these severe storage conditions an increase of the average diameter D_{3,2} of less than 200% can readily be achieved in the present nutritional beverage. Preferably, the increase in D_{3,2} observed under these conditions does not exceed 100%, more preferably it does not exceed 80%, most preferably it does not exceed 60%.

The caloric content of the present nutritional beverage typically is in the range of 0.4-1.7 kcal/ml. Most preferably, the caloric content is in the range of 0.7-1.3 kcal/ml. Of the total caloric content, preferably not more than 40% is provided by fat. Preferably, fat represents between 25 and 35% of the total caloric content of the beverage. Typically, carbohydrates and proteins provide between 35-67% (preferably 55-67%), respectively 10-33% of the total caloric content of the beverage.

Another aspect of the invention relates to a method of preparing a sterilised nutritional beverage as defined herein before, comprising:
combining the protein, fat, carbohydrates, optional other nutritional components and water in a pre-emulsion;
homogenising the pre-emulsion; and
sterilising the homogenised pre-emulsion by heating it to a temperature of more than 130° C. for 2-30 seconds.

The aforementioned sterilisation conditions are typical of so called ultra high temperature (UHT) sterilisation. UHT sterilisation may suitably be achieved in the present method be either direct or indirect heating.

It is important that homogenisation of the pre-emulsion yields an emulsion with very fine oil droplets. Preferably, the oil droplets in the homogenised pre-emulsion exhibit a mean diameter D_{3,2} of 0.1-3 μm, preferably of 0.3-2 μm. Typically, homogenisation is achieved in the present method at a pressure of at least 8 Mpa. Preferably, the pre-emulsion is homogenised at a pressure in the range of 10-30 Mpa.

The invention is further illustrated by means of the following examples.

### EXAMPLES

### Example 1

A nutritional beverage was prepared on the basis of the following recipe:

| Ingredient | Wt. % |
|---|---|
| Skim milk powder | 7.19 |
| Dipotassium phospate | 0.27 |
| Fat | 2.648 |
| Mono/diglycerides (Cremodan ™ Super, | 0.10 |
| Danisco) | |
| Sucrose | 3.94 |
| Maltodextrin DE 20 | 8.90 |
| Native starch (Waxilys ™ 200 ex Roquette) | 0.50 |
| Iron fumarate | 0.0129 |
| Sodium ascorbate | 0.0929 |
| Zinc sulphate | 0.0092 |
| V/M premix | 1.582 |
| Water | Remainder |

The water was weighed and heated to 80° C. Skimmed milk powder was pre-mixed with potassium phosphate and mono/di-glycerides. This mixture was dispersed in the hot water under high speed mixing and hydrated under proper mixing for 15 minutes. An oil blend containing 0.95% DHA was produced using Soybean oil and a DHA concentrate based on Algae oil ex Nutrinova in a ratio of 97.8:2.2%. This oil mixture was added under high speed mixing and pre-emulsified by proper mixing for 15 minutes. Next, the maltodextrin and the native starch was dispersed in this pre-emulsion

A blend containing vitamin C, iron salt, zinc salt and V/M premix was added to the pre-emulsion, followed by the sugar.

The pH was checked and corrected whenever it was below <6.7 using phosphate buffer. The product was homogenised at 175-250 bar and 65-70° C. and thereafter UHT treated at 140° C.-4 sec. Thereafter the product was cooled to 25-30° C. and filled aseptically in PET bottles (250 ml) with a screw cap.

The emulsion so prepared was stored at 40° C. for 4 months. Slight creaming was observed in these samples after this storage period.

### Example 2

A nutritional beverage was prepared in the same way as described in Example 1, on the basis of the following recipe:

| Ingredient | Wt. % |
|---|---|
| Skim milk powder | 5.0 |
| Sodium caseinate | 0.36 |
| Dipotassium phosphate | 0.185 |
| Fat | 2.18 |
| Mono/diglycerides (Cremodan ™ Super, Danisco) | 0.15 |
| Sucrose | 5.0 |
| Native starch (Waxilys ™ 200 ex Roquette) | 1.0 |
| Carrageenan (CL110, Danisco) | 0.025 |
| Iron fumarate | 0.016 |
| Zinc sulphate | 0.008 |
| V/M premix (containing 95.5 wt. % Na-ascorbate) | 0.107 |
| Water | Remainder |

Again the product was found to be highly stable when stored under tropical conditions.

### Comparative Example

Example 1 was repeated except that instead of native starch a modified starch was used (Clearam CR 2010, a modified waxy mais starch ex Roquette). This modified starch is especially developed for use in UHT sterilised products. The emulsion so obtained was stored under the same conditions as the emulsion described in example 1. After 4 months of storage these samples showed dramatic syneresis and creaming.

### Example 3

Four nutritional beverages were prepared in the same way as described in Example 1, on the basis of the following recipe:

| Ingredient | Wt. % |
|---|---|
| Skim milk powder | 5.0 |
| Sodium caseinate | 0.36 |
| Dipotassium phosphate | 0.185 |
| Fat | 2.3 |
| Mono/diglycerides (Cremodan ™ Super, Danisco) | 0.15 |
| Sucrose | 5.75 |
| Native/modified starch | 0.5-1.0 |
| Carrageenan (CL110, Danisco) | 0.025 |
| Mineral blend | 0.024 |
| V/M premix (containing 95.5 wt. % Na-ascorbate) | 0.107 |
| Water | Remainder |

Different starch components (native and modified) were utilized in the concentrations mentioned in the following Table. The samples were stored at the temperature indicated in the table and evaluated by an expert panel after 24 days of storage. Product aspects rated by the panel included stability against creaming and sedimentation, smoothness and homogeneity at pouring and absence of syneresis. The overall ratings of the panel are depicted in the following Table (+=good; +/−=poor; −=unacceptable).

| | | | Overall | | |
|---|---|---|---|---|---|
| | | Level | judgement | | |
| Starch | Type | [%] | 5° C. | 20° C. | 40° C. |
| Waxilys ™ 200 | Native waxy maize | 1 | + | + | + |
| | starch | 0.5 | + | + | + |
| Wheat starch | Native wheat starch | 1 | + | + | + |
| | | 0.5 | + | + | + |
| Clearam ™ | Light modified corn | 1 | − | − | − |
| CH1505 | starch E1422 | 0.5 | + | +/− | − |
| Clearam ™ | Strong modified | 1 | +/− | − | − |
| CH4020 | corn starch E1422 | 0.5 | +/− | +/− | +/− |

After 24 days of storage the samples containing modified starches showed significant phase separation. Such phase separation was not observed in the samples containing native waxy maize starch or native wheat starch.

1. A sterilised nutritional beverage containing:
0.5-8 wt. % protein;
1-6 wt. % fat;
3-20 wt. % carbohydrates;
up to 5 wt. % of optional other nutritional components; and
70-85 wt. % water;
wherein the carbohydrates comprise, calculated on total weight of the beverage:
0.2-2.0% native starch;
2-10% saccharides, selected from the group consisting of monosaccharides, disaccharides, trisaccharides and combinations thereof.

2. Nutritional beverage according to claim 1, wherein the protein is dairy protein

3. Nutritional beverage according to claim 1 or 2, containing 0.1-2 wt. % caseinate.

4. Nutritional beverage according to any one of the preceding claims, containing 0.05-0.5 wt. % of monoglycerides, diglycerides or a combination thereof.

5. Nutritional beverage according to any one of the preceding claims, containing 0.005-0.2 wt. % of carrageenan.

6. Nutritional beverage according to any one of the preceding claims, said beverage having a viscosity (at 20° C.) in the range of 5-200 mPa·s at 10 s⁻¹.

7. Nutritional beverage according to any one of the preceding claims, wherein the native starch is a native waxy maize starch.

8. Nutritional beverage according to any one of the preceding claims, containing between 0.005 and 0.5 wt. % of, preferably between 0.01 and 0.3 wt. % of metal salts.

9. Nutritional beverage according to any one of the preceding claims, wherein the fat is liquid non-hydrogenated oil containing at least 60% unsaturated fatty acid residues by weight of the total amount of fatty acid residues contained in said oil

10. Nutritional beverage according to any one of the preceding claims, wherein the fat is present as dispersed droplets with a diameter D_{3,2} of 0.1-3 μm, preferably of 0.3-2 μm.

11. Nutritional beverage according to any one of the preceding claims, wherein said beverage exhibits excellent storage stability as evidenced by an increase of mean diameter D_{3,2} of less than 200% when the beverage is stored at 40° C. for one month.

12. A method of preparing a sterilised nutritional beverage according to any one of the preceding claims, comprising:
combining the protein, fat, carbohydrates, optional other nutritional components and water in a pre-emulsion;
homogenising the pre-emulsion; and
sterilising the homogenised pre-emulsion by heating it to a temperature of more than 130° C. for 2-30 seconds.
